(19) United States
(12) Patent Application Publication
(10) Pub. No.: US 2019/0083361 A1
(43) Pub. Date: Mar. 21, 2019

(54) TABLET PRINTING DEVICE, TABLET PRINTING METHOD, AND DRUG MANAGEMENT SYSTEM

(71) Applicant: Freund Corporation, Tokyo (JP)

(72) Inventors: Kiyoshi IMAI, Tokyo (JP); Eiichi HACHIYA, Tokyo (JP); Akira MOURI, Tokyo (JP); Satoshi MURAKAMI, Tokyo (JP)

(21) Appl. No.: 16/082,161

(22) PCT Filed: Feb. 27, 2017
(86) PCT No.: PCT/JP2017/007471

§ 371 Date: Sep. 4, 2018

(30) Foreign Application Priority Data
Mar. 11, 2016 (JP) 2016-048452

(51) Int. Cl. A61J 3/00; B65B 5/10; B41J 3/407; B41F 17/36

(52) U.S. Cl. CPC A61J 3/007; B65B 5/103; A61J 2200/42; B41F 17/36; A61J 2200/44; B41J 3/4073

(57) ABSTRACT

A tablet printing device applies print processing to a tablet having an engraved mark display with a recessed groove part. The tablet printing device includes a conveying disk that conveys the tablet while sucking and supporting a side surface of the tablet and an inkjet head capable of applying print processing to the front and back surfaces of the tablet conveyed by the conveying disk. The inkjet head applies print processing to the recessed grooved part of the engraved mark display based on engraving position data obtained by a print surface inspection device. Print processing is performed along the engraved mark display, with the result that the engraved mark display is made clear, significantly improving the visibility thereof.

### TECHNICAL FIELD

The present invention relates to a print processing technique for a tablet on the surface of which a product number, a trademark, a volume, or the like are engraved and, more particularly, to a tablet printing device and method capable of applying print processing to the engraved mark in the same shape as the engraved mark.

### BACKGROUND ART

A product number, a product name, a trademark, a volume or the like (hereinafter, abbreviated as “product number or the like”) is written on the surface of a drug such as a tablet or a capsule for identification of a product and prevention of accidental ingestion. Such a display on the tablet surface is made by engraving at tabletting or print processing such as transfer printing or inkjet printing. It is often the case that the engraving is applied to an uncoated tablet obtained by compression molding of a powder material containing effective ingredients and, in most cases, printing is applied to a coated tablet such as a sugar coated tablet. Print processing by an inkjet system is capable of applying printing to the tablet surface in a non-contact manner and is excellent in sanitation, so that, in recent years, various types printing devices are proposed (e.g., Patent Document 1). Further, in Patent Document 2, there is formed an index part indicating a product name or the like in a recessed part which is formed in the base material of a tablet by inkjet printing.

On the other hand, in recent years, in hospitals, pharmacies, and the like, various drugs are subject to one-dose packaging for individual patients. In this case, in pharmacies and nursing/caring fields, etc., (hereinafter, abbreviated as “pharmacy or the like”), it is necessary to check whether a drug package contains a predetermined number of prescribed drugs without mistake, whether the package is given to a right recipient, and the like. Further, in many cases, generic drugs using off-patent ingredients that contain the same active ingredients differ in tablet shape. Thus, there are cases where tablets differ in shape are given to different recipients, although the recipients are prescribed the same medicine. Therefore, in pharmacies or the like, drugs are managed while confirming displays on tablets to prevent erroneous dispensing for the recipient of the drug.

### CITATION LIST

### Patent Document

Patent Document 1: Japanese Patent No. 5,281,009

Patent Document 2: JP 2013-159582 A

### DISCLOSURE OF THE INVENTION

### Problems to be Solved by the Invention

However, when a product number or the like is shown by the engraved mark, since groove-like engraved mark is formed on the surface of a monochromatic tablet (e.g., white), the engraved mark display is inconspicuous, making a drug name or a volume hard to read. For a tablet, the quality of visibility may lead to erroneous dispensing by pharmacists or accidental ingestion of drug users such as patients and is thus a major problem for both parties and, thus, in the modern age in which elderly persons are increasing, improvement of the visibility of tablets is an urgent task. In particular, when tablets are subject to one-dose packaging using a translucent packaging material such as glassine paper, it becomes more difficult to read the engraved mark display on the tablet surface from outside the package. In this case, it is difficult to definitely confirm a product number or the like without error by a dispenser's visual inspection or by using an inspection device based on image recognition system where it is difficult to properly focus the light on the engraved mark. Thus, a task burden on an administrator in charge in pharmacies or the like is increased due to the one dose packaging. Further, recently, the shape of the drug has been diversified like generic drugs having a variety of shapes or sizes but being the same in ingredient, making it difficult to improve inspection accuracy of drugs without involving an increase in task burden on the administrator.

### Means for Solving the Problems

A tablet printing device according to the present invention includes: a conveying unit that conveys a tablet while sucking and supporting the tablet; and a printing unit disposed in proximity to the conveying unit and capable of applying print processing to the tablet conveyed by the conveying unit. The tablet has an engraved mark display having a recessed groove part, and the printing unit applies print processing to the recessed groove part of the engraved mark display along the engraved mark.

In the present invention, visibility of an engraved mark display is significantly improved by print processing applied to the engraved mark display. The print processing can be applied to existing tablets having an engraved mark display and, thus, it is possible to improve visibility of tablets without changing tabletting dies having conventionally been used. This makes it possible to improve administration workability and inspection accuracy, which in turn can prevent dispensing error or accidental ingestion.

In the tablet printing device, a conveying disk formed into a disk shape may be used as the conveying unit, and suction parts each sucking the tablet may be formed in the end surface thereof in the peripheral direction. In this case, the tablet may be conveyed with the side surface thereof sucked and supported by the conveying unit.

Further, the tablet printing device may further include a print surface inspection device disposed at a stage preceding the printing unit and configured to inspect a printing surface of the tablet. The print surface inspection device has an illumination device for irradiating the printing surface with light and a camera for photographing the engraved mark display formed within the printing surface. The illumination device may have lighting elements arranged along a direction perpendicular to a line connecting the camera and the tablet so that the engraved mark display is irradiated with light substantially horizontally. As a result, the engraved mark display recessed on the tablet surface is shaded, and thus an image including the engraved mark display appearing in relief can be obtained by the camera. Thus, as compared with a conventional inspection device, the engraved mark can be detected more easily, and erroneous determination is more unlikely to occur, making it possible to respond to high-speed print processing.

In this case, the illumination device may be disposed close to the tablet such that a distance (Lp) between the illumination device and the tablet is 1/3 or less and 1/10 or more relative to a distance (La) between the camera and tablet (La/3≥Lp≥La/10).

On the other hand, a tablet printing method according to the present invention includes: conveying a tablet while supporting the tablet; and applying print processing to the conveyed tablet by using a printing unit. The tablet has an engraved mark display having a recessed groove part, and the printing unit applies print processing to the recessed groove part of the engraved mark display along the engraved mark display. In this case, the tablet may be conveyed with the side surface thereof sucked and supported by the conveying unit.

In the present invention, visibility of the engraved mark display is significantly improved by print processing applied to the engraved mark display. The print processing can be applied to existing tablets having the engraved mark display and, thus, it is possible to improve visibility of the tablet without changing a tabletting die that has been conventionally used. This makes it possible to improve administration workability and inspection accuracy, which in turn can prevent dispensing error or accidental ingestion.

A drug management system according to the present invention includes: a drug selection/supply section that selects and supplies prescribed drugs based on dispensing data; a tablet print section that applies predetermined print processing to the tablets supplied from the drug selection/supply section; a tablet packaging section that packages the tablets that have been subjected to the print processing based on the dispensing data; and a package inspection section that collates the packaged tablets with the dispensing data to determine whether or not the prescribed tablets are correctly packaged.

In the present invention, tablets that have been subjected to print processing are packaged in the tablet packaging section, and the packaged tablets are collated with dispensing data by the package inspection section, whereby it is determined whether or not the predetermined tablets are correctly packaged. The package inspection section inspects the tablets that have been subjected to print processing and thus have improved visibility, so that inspection accuracy is significantly increased, and determination accuracy on whether or not the dispensing is correct is dramatically increased.

In the drug management system, the tablet may have an engraved mark display having a recessed groove part, the tablet print section may include a conveying unit that conveys a tablet while sucking and supporting the tablet and a printing unit disposed in proximity to the conveying unit and capable of applying print processing to the tablet conveyed by the conveying unit, and the printing unit may apply print processing to the recessed groove part of the engraved mark display along the engraved mark display. By thus applying the print processing to the engraved mark display, visibility of engraved mark display is significantly improved. It is possible to improve visibility of the tablets without changing tabletting dies that have conventionally been used. This makes it possible to improve administration workability and inspection accuracy, which in turn can prevent dispensing error or accidental ingestion.

### Advantages of the Invention

According to the tablet printing device and method of the present invention, visibility of an engraved mark display itself is significantly improved by print processing applied to the engraved mark of the tablet. This makes it possible to improve administration workability and inspection accuracy, which in turn can prevent dispensing error or accidental ingestion.

According to the drug management system of the present invention, tablets that have been subjected to print processing at the tablet print section are packaged at the tablet packaging section, and the packaged tablets are collated with dispensing data at the package inspection section, whereby it is determined whether or not the prescribed tablets are correctly packaged. Thus, the package inspection section can inspect the tablets that have been subjected to print processing and thus have improved visibility. As a result, inspection accuracy for tablets is significantly increased, and determination accuracy on whether or not the dispensing is correct is dramatically increased.

### BRIEF DESCRIPTION OF THE DRAWINGS

FIG. 1 An explanatory view illustrating the entire configuration of a tablet printing device according to an embodiment of the present invention.

FIG. 2 Explanatory views each illustrating an example of a tablet subjected to print processing by the tablet printing device of FIG. 1, in which FIG. 2A illustrates a state before print processing, and FIG. 2B illustrates a state after print processing.

FIG. 3 An explanatory view illustrating the configuration of a print surface inspection device.

FIG. 4 Explanatory views each illustrating a tablet image obtained by the print surface inspection device, in which FIG. 4A is an image obtained by a conventional device, and FIG. 4B is an image obtained by the print surface inspection device of the tablet printing device.

FIG. 5 An explanatory view illustrating an example of a dispensing form.

FIG. 6 A block diagram illustrating the configuration of a drug management system based on one-dose packaging for the tablets that have been subjected to print processing by the tablet printing device according to the present invention.

### BEST MODE FOR CARRYING OUT THE INVENTION

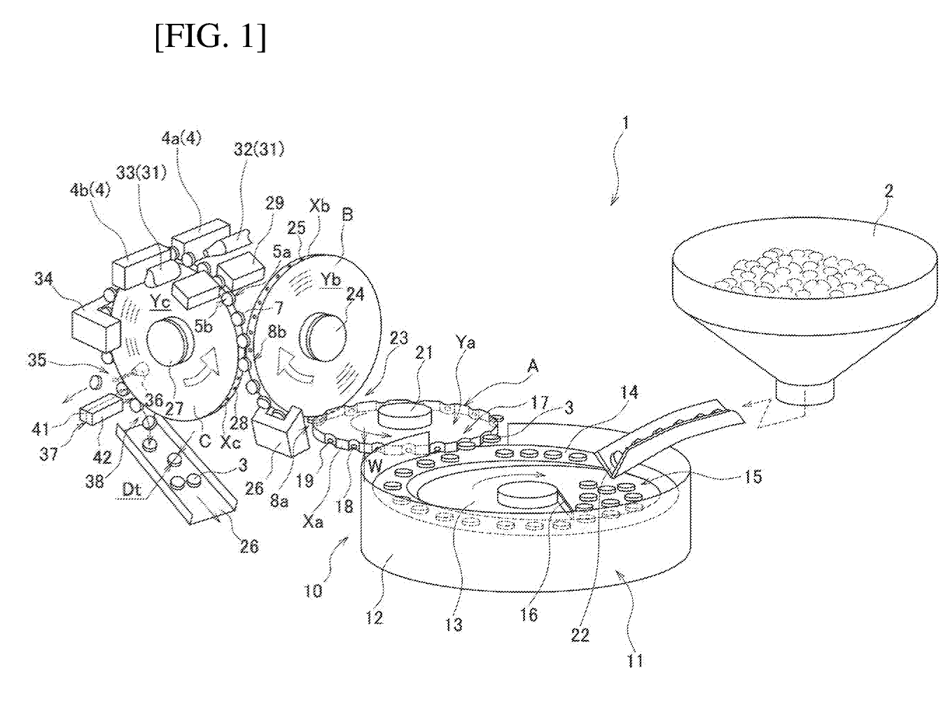

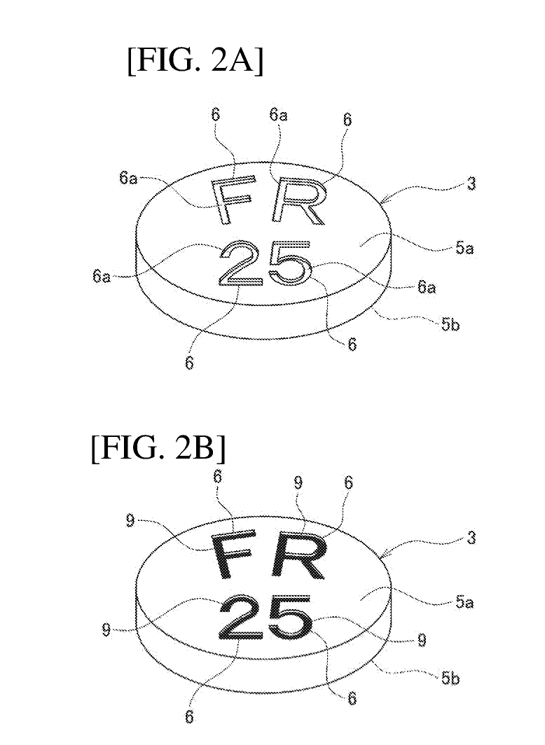

An object of the following embodiment is to improve accuracy of drug inspection and reduce erroneous dispensing and to reduce a task burden on an administrator in charge in pharmacies or the like by improving visibility of an engraved mark display on a tablet. FIG. 1 is an explanatory view illustrating the entire configuration of a tablet printing device 1 according to an embodiment of the present invention. FIGS. 2A and 2B are explanatory views each illustrating an example of a tablet subjected to print processing by the tablet printing device 1. The tablet printing device 1 of FIG. 1 sucks and conveys tablets 3 fed from a hopper 2 one by one with three conveying disks A, B, and C formed into a disk shape. Then, inkjet head 4 is used to apply print processing to front and back surfaces 5a and 5b of the tablet 3. On the front and back surfaces 5a and 5b of the tablet 3, characters, graphics, symbols, or a combination thereof showing a product number or the like are each formed by an engraved mark 6. The inkjet head 4 fills a recessed groove part 6a of the engraved mark 6 with ink 9.

As illustrated in FIG. 2, a tablet identification code (symbol) “FR” and a volume “25” (25 mg) are formed by the engraved mark 6 as a product number or the like on the front and back surfaces 5a and 5b of the tablet 3. The engraved mark 6 is formed on the front and back surfaces 5a and 5b in a recessed groove shape using a molding die (mortar, pestle; not illustrated) at tabletting of the tablet 3. In the tablet printing device 1, the inkjet head 4 is used to apply print processing to the recessed groove part 6a of the engraved mark 6. That is, the inkjet head 4 is used to apply the ink 9 so as to trace the engraved mark 6. As illustrated in FIG. 2A, it is difficult to make a distinction between the engraved mark 6 and the other portions on the tablet surface before the print processing, while after the print processing, the engraved mark 6 has a color different from that of its surrounding, with the result that a symbol or a number on the tablet surface appears in relief.

In the tablet printing device 1, the tablets 3 are transferred from the conveying disk A (tablet supply disk) to the conveying disk B (first conveying disk) at a tablet delivery part 8a. Further, at a tablet delivery part 8b, the tablets 3 are transferred from the conveying disk B to the conveying disk C (second conveying disk). In the conveying disks A and C, the side surface 7 of each tablet 3 is sucked to and supported on end surfaces (tablet holding parts) Xa and Xc of the respective disks. In the conveying disk B, the front surface 5a or back surface 5b of each tablet 3 is sucked to and supported on an end surface (tablet holding part) Xb of the disk. The tablet 3 is conveyed to the inkjet head 4 in a standing state (standing posture) where the side surface 7 is directed in the vertical direction. Then, the front and back surfaces 5a and 5b of the tablet 3 are subjected to printing at the same time by the inkjet head 4, only good products are discharged outside the device through a good product discharge part 38.

As illustrated in FIG. 1, the tablet printing device 1 is provided with the hopper 2, a rotary feeder (tablet feeder) 11, and the conveying disk A as a tablet supply unit 10. The hopper 2 stores the tablets 3 and feeds them to the rotary feeder 11. The rotary feeder 11 feeds the tablets 3 received from the hopper 2 to the conveying disk A. The conveying disk A sucks and conveys the tablets 3 from the rotary feeder 11 to the tablet delivery part 8a. The rotary feeder 11 is a so-called vibrationless rotary parts feeder and has a configuration in which a rotary disk 13 and an annular rotary plate 14 are coaxially provided in a cylindrical casing 12. The annular rotary plate 14 is disposed immediately inside the casing 12. The rotary disk 13 is disposed inside the annular rotary plate 14 in an inclined state. Apart of the outer periphery of the rotary disk 13 has the same height as the annular rotary plate 14 and the part serves as a communication part 15 between the rotary disk 13 and the annular rotary plate 14. The communication part 15 is provided with a guide plate 16 for guiding the tablets on the rotary disk 13 toward the annular rotary plate 14 side.

The casing 12 is partially cut out. The conveying disk A is disposed in such a manner that the outer peripheral portion thereof faces the cut out portion of the casing 12 to form a tablet acquisition part 17. The end surface Xa of the conveying disk A has a width W smaller than a maximum diameter Dt of the tablet 3. The end surface Xa has a plurality of circular suction holes (suction parts) 18 which are arranged at equal intervals in the peripheral direction. The suction holes 18 are connected to a suction device (not illustrated) such as a vacuum pump. A recessed part 19 in which the tablet 3 is introduced is formed around each of the suction holes 18 formed in the end surface Xa. The conveying disk A is disposed with a disk surface Ya thereof being substantially horizontal and is rotated about a vertically extending rotary shaft 21 in a direction denoted by the arrow by a drive source (not illustrated). As illustrated in FIG. 1, the conveying disks B and C provided at stages subsequent to the conveying disk A are disposed with disk surfaces Yb and Yc thereof being upright. On the other hand, the conveying disk A is disposed with the disk surface Ya being horizontal like a turn table. At the tablet acquisition part 17, the tablet 3 is sucked at its side surface 7 to the suction hole 18 of the conveying disk A and then conveyed to the conveying disk B in a horizontal posture (in a state where the front and back surfaces 5a and 5b face upward and downward in the vertical direction).

In the rotary feeder 11, the tablet 3 supplied from the hopper 2 is fed from a tablet supplying part 22 onto the rotating rotary disk 13. The tablet 3 on the rotary disk 13 moves in the peripheral direction with rotation of the rotary disk 13 and is then guided by the guide plate 16 to the annular rotary plate 14 being rotated at the same speed as the rotary disk 13. The tablet 3 on the annular rotary plate 14 moves in the peripheral direction with rotation of the annular rotary plate 14 to be fed to the tablet acquisition part 17. The tablet 3 fed to the tablet acquisition part 17 faces the end surface Xa of the rotating conveying disk A. At this time, if the tablet 3 coincides in posture and timing with the suction hole 18, it is sucked to the suction hole 18 while being fitted in the recessed part 19. That is, the tablet 3 sucked in a proper posture is conveyed by the conveying disk A to a tablet feeding part 23 which is a contact point with the conveying disk B. On the other hand, if the tablet 3 does not coincide in posture and timing with the suction hole 18 and thus is not sucked to the suction hole 18, it stays on the rotating rotary disk 13. That is, any tablet that does not assume a suction posture returns to the rotary feeder 11 and is then automatically conveyed toward the tablet acquisition part 17 once again (automatic return/automatic retry).

In the tablet printing device 1, the tablet 3 is sucked and conveyed from the rotary feeder 11 to the tablet feeding part 23 using the conveying disk A. By this suction conveyance, the tablet 3 can be picked up and fed to the conveying disk B in a guideless configuration where a guide member matching a tablet size is not used. In recent years, drugs, such as generic drugs, having different size or shape while maintaining the same ingredient are widely accepted in the market. Further, there are many cases that tablets of various sizes having different prescriptions exist although they are the same drugs. However, in a configuration where the guide member matching the tablet size provided between the tablet feeder and the tablet feeding part 23 is used to align the tablets 3 and guide them to the tablet feeding part 23, the guide member needs to be replaced by a proper one every time the size of the tablet is changed. Thus, even in the case of tablets of the same ingredient like the generic drug, when the sizes thereof are different, component replacement is required. Further, every time the component is replaced, the operation of the device must be interrupted to perform replacement/cleaning work, taking much labor and increasing processing time.

In contrast to this, in the tablet printing device 1, the tablet 3 is fed to the tablet feeding part 23 not using the guide member, but by the conveying disk A. As a result, the tablet can be fed to the subsequent stage in a proper posture irrespective of the tablet size as long as the tablet can be sucked to the disk, thereby flexibly dealing with tablets of various sizes. Thus, tablets of the same ingredients having various sizes can be conveyed in a mixed state, thereby significantly improving the processing efficiency. Further, the tablet printing device 1 performs print processing while the conveying disks B and C arranged at subsequent stages perform suction conveyance, so that it is also possible to achieve desired printing irrespective of the tablet size. That is, using the conveying disk A allows achievement of effective print processing exerting the features of the device at the maximum. Further, the tablet printing device 1 is not provided with a conveying guide, so that exchange or cleaning thereof need not be performed, thereby reducing man-hours for device maintenance. Additionally, the arrangement pitch of the suction holes 18 is previously determined, so that it is possible to prevent a large number of tablets exceeding the processing capacity from being fed to the tablet feeding part 23, which in turn prevents problems of jamming of tablets.

The tablet 3 is conveyed to the tablet feeding part 23 with rotation of the conveying disk A while maintaining the horizontal posture. Then, at the tablet delivery part 8a, the tablet 3 is handed over from the conveying disk A to the conveying disk B. At the tablet feeding part 23, the end surface Xa of the conveying disk A is disposed so as to adjacently face the end surface Xb of the conveying disk B in an orthogonal state, and the tablet delivery part 8a is formed between the conveying disks A and B. The conveying disks A, B, and C are synchronously driven so that the conveying speed of the tablet 3 is made constant considering transfer of the tablet therebetween. The conveying disk B is rotated about a rotary shaft 24 in a direction denoted by the arrow by a drive source (e.g., an electric motor; not illustrated). The end surface Xb of the conveying disk B has a flat surface with no projection. The end surface Xb has a plurality of circular suction holes (suction parts) 25 which are arranged at equal intervals in the peripheral direction. Like the suction holes 18, the suction holes 25 are connected to a suction device (not illustrated) such as a vacuum pump. The tablet 3 fed to the tablet feeding part 23 is sucked to the end surface Xb of the conveying disk B by the suction hole 25. At this time, the tablet 3 is held to the end surface Xb with one of the front and back surfaces 5a and 5b sucked thereto.

A side surface inspection device 26 is disposed near the conveying disk B. The side surface inspection device 26 is used for inspecting a state (presence/absence of cracking and chipping) of the side surface 7 of the tablet 3 sucked to and supported by the conveying disk B (side surface inspection). In the tablet printing device 1, a camera is used as the inspection device for inspecting the outer appearance or a printed state of the tablet. An image photographed by the inspection device is sent to a controller (not illustrated), where determination of nondefective/defective is made. A light and a pair of prisms are provided in the photographing range of the camera used for the side surface inspection device 26. The pair of prisms are disposed so as to face the tablet side surface. The camera photographs the state of the tablet side surface illuminated by the light 180 degrees at a time by two prisms. The side surface inspection device 26 can not only inspect the outer appearance of the tablet 3, but also measure the thickness thereof, so it can also determine a dimensional error. A tablet 3 in which any abnormality is detected is recognized as a defective and discharged through a defective product discharge part 35 provided at a stage subsequent to the conveying disk C without being subjected to print processing.

The tablet 3 sucked to the end surface Xb of the conveying disk B is put into an upright posture (a state where the side surface 7 is directed in the vertical direction) from the horizontal posture with rotation of the conveying disk B, subjected to the inspection by the side surface inspection device 26, and fed to the tablet delivery part 8b. The conveying disk C is disposed at the tablet delivery part 8b. The conveying disk C is rotated about a rotary shaft 27 in a direction denoted by the arrow by a drive source (not illustrated). The conveying disks B and C are disposed such that the rotary shafts 24 and 27 thereof are orthogonal to each other and are synchronously driven so as to convey the tablets at the same speed. As in the conveying disk B, an end surface Xc of the conveying disk C also has a flat surface with no projection. A width W of the end surface Xc is also smaller than the maximum diameter Dt of the tablet 3. The end surface Xc of the conveying disk C also has circular suction holes (suction parts) 28 which are arranged at equal intervals in the peripheral direction. The end surfaces Xb and Xc of the respective conveying disks B and C are disposed so as to adjacently face each other at the tablet delivery part 8b in an orthogonal state.

The tablet 3 is sucked to the end surface Xb of the conveying disk B at the tablet delivery part 8a and conveyed to the tablet delivery part 8b with rotation of the conveying disk B. The tablet 3 conveyed to the tablet delivery part 8b is sucked to the end surface Xc of the conveying disk C there and is then handed over to the conveying disk C side. In this case, at the conveying disk B side, suction force is imparted to the suction holes 25 until they reach a position at which both the disks B and C are closest to each other at the tablet delivery part 8b. The tablet 3 is sucked to the suction hole 28 of the opposing conveying disk C from the suction hole 25 losing the suction force at the disk closest approach position, and the tablet 3 is transferred to the conveying disk C.

The tablet 3 is sucked to the conveying disk B at one of its front and back surfaces 5a and 5b, so that the side surface 7 of the tablet 3 faces the end surface Xc of the conveying disk C at the tablet delivery part 8b. Thus, at the conveying disk C side, the side surface 7 of the tablet 3 is sucked and, accordingly, the tablet 3 is held to the end surface Xc in a standing state. Clearances between the conveying disks A, B, and C at the tablet delivery parts 8a and 8b can be changed in dimension according to the size of the tablet 3 and is automatically adjusted by inputting the tablet size through a control panel.

A print surface inspection device 29 is disposed at a stage following the tablet delivery part 8b in proximity to the conveying disk C. The print surface inspection device 29 inspects the states of the front and back surfaces 5a and 5b as the surfaces to be printed of the tablet 3 sucked to and supported by the conveying disk C (print surface inspection). At this time, for the tablet 3 having the engraved mark 6, the position or arrangement of the engraved mark 6 is also detected by the print surface inspection device 29. Further, the position of a scoring line can also be detected by the print surface inspection device 29. As in the case of the side surface inspection device 26, a tablet 3 for which defective outer appearance is detected is recognized as defective and discharged through the defective discharge part 35 without being subjected to print processing.

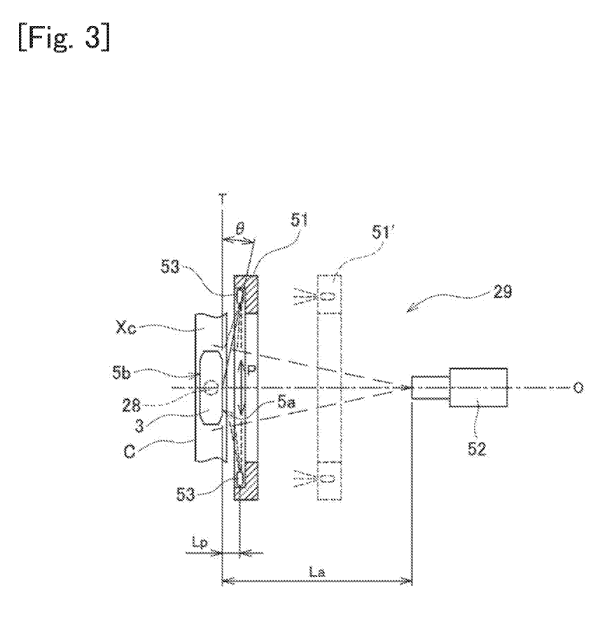

FIG. 3 is an explanatory view illustrating the configuration of the print surface inspection device 29. The print surface inspection device 29 includes an illumination device 51 for irradiating the front and back surfaces 5a and 5b of the tablet 3 with light and a camera 52 for photographing the front and back surfaces 5a and 5b. The illumination device 51 is a ring illumination device that uses high-luminance LEDs (lighting elements) 53. As illustrated in FIG. 3, the LEDs 53 are arranged along a direction (direction P in FIG. 3: in this example, a direction parallel to the front and back surfaces 5a and 5b) perpendicular to a line (center line O) connecting the camera 52 and the tablet 3 so as to face the circumferential center.

In the tablet printing device 1, the illumination device 51 is disposed closer to the tablet 3 than in a conventional print surface inspection device. As denoted by the dashed line in FIG. 3, an illumination device 51′ of the conventional illumination device is disposed at the intermediate position between the camera 52 and the tablet 3 or disposed closer to the camera than the intermediate position. On the other hand, in the print surface inspection device 29, a distance Lp between the illumination device 51 and the tablet 3 is 1/3 or less and 1/10 or more of a distance La between the camera 52 and the tablet 3 (La/3≥Lp≥La/10).

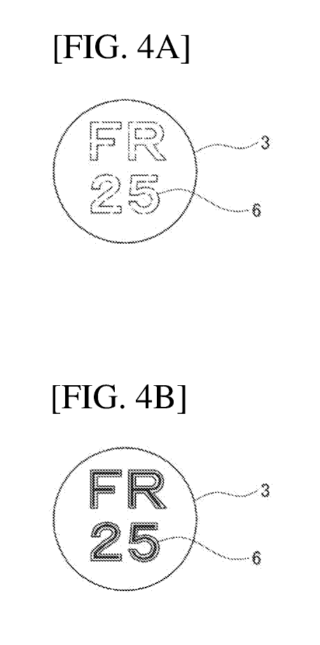

In the conventional inspection device, in order to illuminate brightly the tablet surface, LEDs or the like are arranged to face the tablet surface so that a uniform light beam is irradiated onto the tablet from the front, and the illumination device 51′ is disposed at the position denoted by the dashed line in FIG. 3. However, when illuminating the tablet 3 at that position, lighting is flattened although the light is uniformed, with the result that the scoring line or engraved mark becomes unclear in an obtained image as illustrated in FIG. 4A. This prevents the scoring line or engraved mark from being clearly recognized, making erroneous determination more likely to occur.

In contrast to this, in the print surface inspection device 29, since the tablet 3 is conveyed by the conveying disk C while being sucked thereto, the illumination device 51 can be disposed very close to the tablet 3. Thus, the front and back surfaces 5a and 5b of the tablet 3 are irradiated with light in a state of being close to horizontal light emitted from the LEDs 53. That is, the front and back surfaces 5a and 5b are irradiated with gradient light with a shallow angle (θ=about 10° to about 30° with respect to a tangent line T passing through the apex of the front and back surfaces 5a and 5b) emitted from the illumination device 51. As a result, the scoring line or engraved mark recessed on the tablet surface is shaded, and thus an image in which the scoring line or engraved mark clearly appearing in relief is obtained by the camera 52 (FIG. 4B). Thus, as compared with the conventional inspection device, the scoring line or engraved mark can be detected more easily, and erroneous determination is more unlikely to occur, making it possible to respond to high-speed print processing.

The inkjet head 4 is disposed at a stage following the print surface inspection device 29. In the tablet printing device 1, a powder removing device 31 is provided before the inkjet head 4. The powder removing device 31 blows compressed air to the tablet 3 from a nozzle 32 to remove powder adhering to the tablet surface immediately before printing. The powder blown off from the tablet surface is collected by a suction tube 33. Powder of, e.g., drug adheres to the surface or engraved mark 6 of a tablet formed by a tabletting machine. If print processing is applied to the graved mark 6 without removing the powder, print applied to the engraved mark 6 may be erased together with the powder. To cope with this problem, in the tablet printing device 1, the powder removing device 31 is disposed immediately before the inkjet head 4. As a result, powder adhering to the engraved mark 6 is removed. In addition, print processing can be performed before generation of new powder. Thus, it is possible to prevent the print applied to the engraved mark 6 from falling off with the powder adhering to the engraved mark 6, making it possible to achieve clear and high-quality printing.

After clearance of the tablet surface by the powder removing device 31, the inkjet head 4 is used to apply predetermined print processing to the front and back surfaces 5a and 5b of the tablet 3 and to apply the ink 9 into the recessed groove part 6a. In the tablet printing device 1, the position of the engraved mark 6 is correctly detected by the print surface inspection device 29, and the inkjet head 4 performs print processing for the recessed groove part 6a based on a result of the detection (engraving position data). At this time, the tablet 3 is conveyed while being sucked to the conveying disk C, so that, unlike a case where the tablet is conveyed by a belt, the tablet 3 does not undergo displacement between the print surface inspection device 29 and the inkjet head 4. That is, the tablet 3 is conveyed to the inkjet head 4 in a state of being positioned correctly. Thus, with the inkjet head 4, print processing is surely applied to the engraved mark 6, thereby obtaining clear and displacement-free printing.

Further, during print processing by the inkjet head 4, the tablet 3 is supported with the side surface 7 sucked, and thus the entire front and back surfaces 5a and 5b are exposed. Thus, in the tablet printing device 1, print processing can be applied to the entire front and back surfaces 5a and 5b of the tablet 3, and an area where printing cannot be applied is not generated in the peripheral edge of the tablet. Furthermore, in the inkjet head 4, an inkjet head 4a for front surface and an inkjet head 4b for back surface are disposed so as to face each other at the same position, so that print processing can be applied to the front and back surfaces 5a and 5b of the tablet 3 at the same time by the heads. In this case, the inkjet head 4a for front surface and the inkjet head 4b for back surface are disposed so as to face each other at the same position; however, they may be displaced from each other. Further, another head may be provided to accommodate multicolor printing, multilayer printing, or side-surface printing.

As described above, the tablet 3 is applied with the ink 9 along the engraved mark 6 by the inkjet head 4, it is printed shown as FIG. 2B. Although only the front surface 5a is illustrated in FIG. 2, the same print processing is applied to the back surface 5b. In this example, the symbol “FR” and volume “25” are formed by the engraved mark 6 on both the front and back surfaces 5a and 5b of the tablet 3, and the display of the engraved mark 6 is made clear by the print processing (see FIG. 2B). This print processing can be applied to existing tablets having an engraved mark display and, thus, it is possible to significantly improve visibility of the engraved mark display without changing a tabletting die (mortar, pestle) that has conventionally been used. Further, administrators or tablet users can easily visually confirm the type or volume of the tablet 3, thus making it possible to improve administration workability and to prevent dispensing error or accidental ingestion.

Further, in the tablet 3, the ink 9 is applied to the graved mark 6, so that print is not erased easily. For example, when print processing is applied to the surface of an orally disintegrable tablet (OD tablet) or an uncoated plain tablet, the printing may be worn off and damaged together with the ink or may be transferred to another or other tablets due to rubbing between the tablets. In contrast to this, in the tablet 3, the ink 9 exists in the recessed groove part 6a, so that even when tablets are rubbed against each other, the ink 9 does not fall out, thus making it possible to prevent wearing damage or transfer of printing and to ensure visibility over a long period of time.

A print inspection device 34 is provided at a stage subsequent to the inkjet head 4. The print inspection device 34 is provided for checking a result of printing performed by the inkjet head 4. When a printing defect is detected by the print inspection device 34, the corresponding tablet is discharged through the defective product discharge part 35 provided at a stage subsequent to the print inspection device 34. The defective product discharge part 35 is provided with a jet nozzle 36 that blows compressed air. A tablet 3 determined to have a defect in outer appearance or printing is blown off from the conveying disk C by the air blown from the jet nozzle 36 to be removed.

A drying/cooling device 37 is provided at a stage subsequent to the defective product discharge part 35. When the tablet 3 is conveyed to the good product discharge part 38 while the print part thereof is yet to be dried, the ink 9 may adhere to a carrying-out path 39 or print blurring may occur. In order to cope with this problem, in the tablet printing device 1, the drying/cooling device 37 is provided at a stage preceding the good product discharge part 38 so as to dry the print part and solidify the ink 9. The drying/cooling device 37 is provided with a heating nozzle 41 and a cooling nozzle 42. In the drying/cooling device 37, the solvent of the ink 9 is vaporized by hot air from the heating nozzle 41, and then the ink 9 is cooled by cooling air from the cooling nozzle 42 to the melting point or lower thereof for solidification. Then, the print is fixed to the tablet surface, and only tablets 3 determined to be non-defective are discharged through the good product discharge part 38. As a result, it is possible to prevent the tablets determined to be non-defective from being stained by the ink 9 adhering to the carrying-out path 39 and to prevent print blurring due to rubbing of the print surface when the tablets 3 is rolling down the carrying-out path 39, thereby improving product quality and yield.

As described above, in the tablet printing device 1, print processing is performed while sucking and supporting the side surface 7 of the tablet 3, so that the entire front and back surfaces 5a and 5b of the tablet 3 are not covered with the guide or the like for supporting the tablet. This allows inspection or print processing to be performed in a state where the surface to be printed is exposed, and prevents an area where inspection or print processing cannot be applied from being generated at the peripheral portion on the front and back surfaces of the tablet. Further, both the front and back surfaces can be subjected to printing without involving reversal of the tablet 3, thereby eliminating the risk of ink transfer or print blurring associated with the reversal of the tablet.

Thus, according to the tablet printing device 1, desired print can be efficiently applied to the entire front and back surfaces, thereby achieving reduction in printing time and device size. Further, in the tablet printing device 1, the tablet 3 is conveyed to the position of the inkjet head 4, not using a conveying tool such as a magazine, but in a state of being sucked to and supported by the conveying disk C. Thus, in the inkjet head 4, the tablet 3 can pass just near the head nozzle, allowing the distance between the head and the tablet to be reduced as much as possible. Thus, printing accuracy with respect to the front and back surfaces can be enhanced to thereby realize the tablet printing enhanced in quality.

Further, in the inkjet head 4 of the tablet printing device 1, an ink ejection amount is adjusted according to the shape of the front and back surfaces 5a and 5b, so that even when the print surface is a curved surface, printing can be performed such that the ink does not run off the engraved mark 6. For example, in the case of a tablet whose front and back surfaces are spherical, there occurs a difference between the distance between the center portion of the tablet and the head nozzle and the distance between the peripheral portion thereof and the head nozzle, so that when print processing is performed under the same condition for both of the above portions, printing may be distorted in the peripheral region of the tablet, with the result that the ink 9 may run off the engraved mark 6. Thus, in order to cope with this problem, in the tablet printing device 1, the ejection amount of the head nozzle is adjusted based on shape information of the tablet so as to prevent the ink 9 from running off the engraved mark 6. While the shape information of the tablet can be input by way of a control panel of the device, thickness or outer diameter data of the tablet 3 measured by the side surface inspection device 26 can also be used.

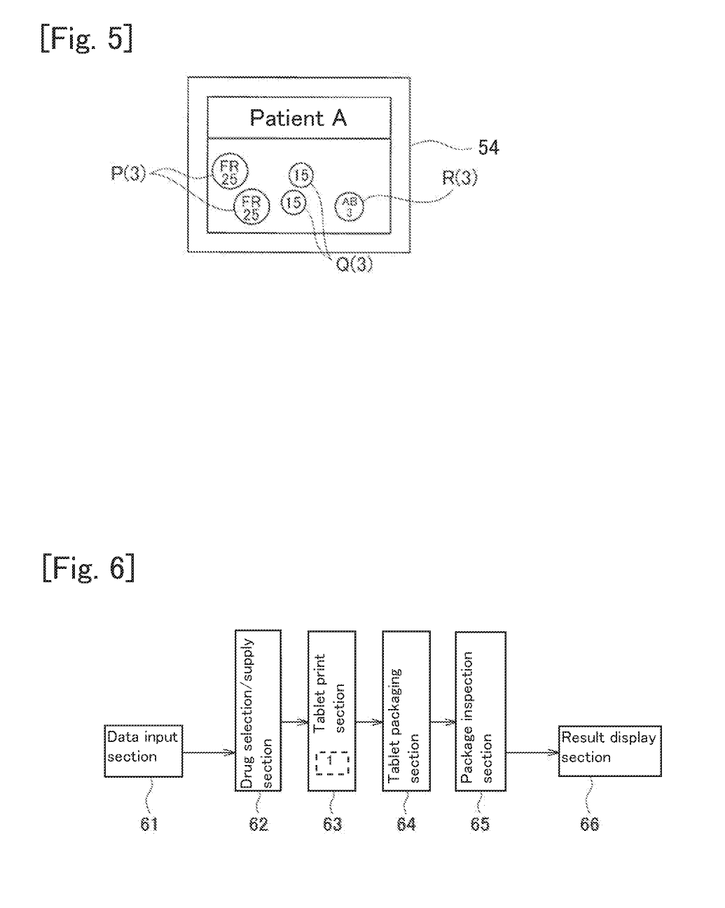

In recent years, as described above, the one-dose packaging system has been advancing in view of preventing accidental ingestion or loss of tablets. FIG. 5 is an explanatory view illustrating an example of a dispensing form. For example, assume that drugs prescribed for a patient A include “tablet P×2”, “tablet Q×2”, and “R”, and that they are packaged in a single supply as illustrated in FIG. 5 (package 54). In this case, the dispenser has to carry out a visual dispensing work for the packages 54 each containing five tablets and which is 14 days' worth of medication (three packages per day), namely 43 packages in total, which is very troublesome work, and a check error is apt to occur. In particular, in a tablet only with the engraved mark, the engraved mark itself is indistinct and a check work is therefore troublesome, which may lead to omission of inspection. Thus, recently, it is often the case that inspection is carried out by an inspection device at medication as well as a check by visual observation in order to prevent dispensing errors.

At this time, in the tablet 3 that has been subjected to print processing by the tablet printing device 1, the engraved mark 6 is clearly seen, thus significantly facilitating a check work by visual observation and increasing determination accuracy by inspection using the inspection device on whether or not the dispensing is correct or not. In particular, visibility in a case where a translucent packaging material is used for packaging is significantly improved, resulting in a large increase in accuracy of the check work or inspection. The following describes a drug management system attaining an increase in determination accuracy on whether or not the dispensing is correct or not by installing the tablet printing device 1 according to the present invention. FIG. 6 is a block diagram illustrating the configuration of a drug management system using the tablet printing device according to the present invention.

As illustrated in FIG. 6, the drug management system includes a drug selection/supply section 62, a tablet print section 63, a tablet packaging section 64, and a package inspection section 65. The drug selection/supply section 62 selects predetermined drugs based on a prescription (dispensing data) input through a data input section 61, picks up the selected tablets from a PTP (Press Through Package), and supplies them to the subsequent stage tablet print section 63. The tablet print section 63 has the tablet printing device 1 according to the present invention and applies the above-described print processing to the engraved mark 6 of each of the supplied tablets 3. The tablet packaging section 64 forms the package 54 by packaging the tablets 3 that have been subjected to the print processing according to the prescription in one supply.

The package inspection section 65 inspects the tablets in the package 54 and collates the inspection result with dispensing data. At this time, the engraved marks 6 of the tablets 3 have been subjected to print processing, so that inspection accuracy is high, and determination accuracy on whether or not the dispensing is correct or not is also high. When the actual inspection data and dispensing data coincide with each other, the package inspection section 65 determines “correct”, while when the actual inspection data and dispensing data do not coincide with each other, the package inspection section 65 determines “incorrect”. The determination result in the package inspection section 65 is notified to the administrator in charge through a result display section 66 with an image or voice.

As described above, by using the tablet printing device 1 according to the present invention, visibility of the engraved mark formed on the tablet is significantly improved. Thus, as compared with a tablet only with the engraved mark, it is possible to significantly increase inspection accuracy and thereby to dramatically increase determination accuracy on whether or not the dispensing is correct. This can significantly reduce dispensing error and can also reduce a task burden on the administrator. In particular, when a large number of tablets are subject to one-dose packaging, both the inspection accuracy and task burden are significantly improved. Further, the inspection data can be stored reliably, so that traceability can be ensured. Furthermore, even under the circumstances where tablets having a variety of shapes or sizes but same in ingredient or where the shape of the tablet is diversified like generic drugs, it is possible to increase accuracy of drug inspection without increasing the burden on the administrator.

The present invention is not limited to the above-described embodiment and may be variously changed within the scope of the invention.

For example, although circular tablets are subjected to print processing in the above embodiment, the tablet printing device according to the present invention may be applied not only to the circular tablets, but also to various types of tablets such as oblong tablets, caplets, and polygon-shaped tablets. Thus, the “tablet” in the present invention is a concept that includes not only so-called circular tablets, but also tablets of various shapes.

Further, the shape of the suction hole formed in the conveying disk of the above embodiment is not limited to a circular shape, but may be an elliptical or polygonal shape. Further, a curved suction groove having an inner peripheral surface matching the tablet outer shape may be formed together with the suction hole. In this case, as the shape of the suction groove, various shapes such as a V- or U-like shape or a quadrangular shape may be adopted. For example, a substantially V-shaped groove may be formed in the tablet feeding disk so as to correspond to odd-shaped tablets such as triangular tablets. The most common shape of the tablet is a disk shape, and thus the groove is desirably formed into a curved shape to which the tablets slightly different in size can be fitted. A recessed part similar to that of the conveying disk A may be formed in the end surfaces Xb and Xc of the conveying disks B and C, and conversely, the end surface Xa of the conveying disk A may be formed into a flat surface like the conveying disks B and C.

Further, as required, it is possible to omit print processing on one of the front and back surfaces 5a and 5b, or to add another inkjet head for applying print processing to the side surface 7 of the tablet 3. For example, when print processing is applied to only one of the front and back surfaces 5a and 5b, a configuration may be adopted, in which an inkjet head is disposed near the disk B, and disc C is omitted. Further, while the illumination device that emits light in the horizontal direction and the camera are used in the print surface inspection device incorporated in the tablet printing device according to the present embodiment, a 3D recognition device using a laser light may be used to detect the engraved mark.

### INDUSTRIAL APPLICABILITY

The present invention may be applied to printing for medical tablets, but also for food such as confectionery having a tablet shape.

### REFERENCE SIGNS LIST

1: Tablet printing device
2: Hopper
3: Tablet
4: Inkjet head
4a: Inkjet head for front surface
4b: Inkjet head for back surface
5a: Tablet front surface
5b: Tablet back surface
6: Engraved mark
6a: Recessed groove part
7: Tablet side surface
8a: Tablet delivery part
8b: Tablet delivery part
9: Ink
10: Tablet supply unit
11: Rotation feeder
12: Casing
13: Rotary disk
14: Annular rotary plate
15: Communication part
16: Guide plate
17: Tablet acquisition part
18: Suction hole
19: Recessed part
21: Rotary shaft
22: Tablet supplying part
23: Tablet feeding part
24: Rotary shaft
25: Suction hole
26: Side surface inspection device
27: Rotary shaft
28: Suction hole
29: Print surface inspection device
31: Powder removing device
32: Nozzle
33: Suction tube
34: Print inspection device
35: Defective discharge part
36: Jet nozzle
37: Cooling device
38: Good article discharge part
39: Carrying-out path
41: Heating nozzle
42: Cooling nozzle
51: Illumination device
51′: Illumination device
52: Camera
53: LED
54: Package
61: Data input section
61: Drug selection/supply section
63: Tablet print section
64: Tablet packaging section
65: Package inspection section
66: Result display section
A: Conveying disk
B: Conveying disk
C: Conveying disk
Dt: Tablet maximum diameter
La: Distance
Lp: Distance
O: Center line
T: Tangent line
Xa: Disk end surface
Xb: Disk end surface
Xc: Disk end surface
Ya: Disk surface
Yb: Disk surface
Yc: Disk surface

1. A tablet printing device characterized by comprising:
a conveying unit that conveys a tablet while sucking and supporting the tablet; and
a printing unit disposed in proximity to the conveying unit and capable of applying print processing to the tablet conveyed by the conveying unit, wherein
the tablet has an engraved mark display having a recessed groove part, and
the printing unit applies print processing to the recessed groove part of the engraved mark display along the engraved mark display.

2. The tablet printing device according to claim 1, wherein
the conveying unit is a conveying disk formed into a disk shape, and
the conveying disk has suction parts formed in the end surface thereof in the peripheral direction and each sucking the tablet.

3. The tablet printing device according to claim 1, wherein
the conveying unit conveys the tablet while sucking and supporting the side surface of the tablet.

4. The tablet printing device according to claim 1, characterized by further comprising a print surface inspection device disposed at a stage preceding the printing unit and configured to inspect a printing surface of the tablet, wherein
the print surface inspection device has an illumination device for irradiating the printing surface with light and a camera for photographing the engraved mark display formed within the printing surface, and
the illumination device has lighting elements arranged along a direction perpendicular to a line connecting the camera and the tablet so that the engraved mark display is irradiated with light substantially horizontally.

5. The tablet printing device according to claim 4, wherein
a distance (Lp) between the illumination device and the tablet is 1/3 or less and 1/10 or more of a distance (La) between the camera and the tablet (La/3≥Lp≥La/10).

6. A tablet printing method characterized by comprising:
conveying a tablet while sucking and supporting the tablet; and
applying print processing to the conveyed tablet by using a printing unit, wherein
the tablet has an engraved mark display having a recessed groove part, and
the printing unit applies print processing to the recessed groove part of the engraved mark display along the engraved mark display.

7. The tablet printing method according to claim 6, characterized by comprising conveying the tablet while sucking and supporting the side surface of the tablet.

8. A drug management system characterized by comprising:
a drug selection/supply section that selects and supplies prescribed drugs based on dispensing data;
a tablet print section that applies predetermined print processing to the tablets supplied from the drug selection/supply section;
a tablet packaging section that packages the tablets that have been subjected to the print processing on the basis of the dispensing data; and
a package inspection section that collates the packaged tablets with the dispensing data to determine whether or not the prescribed tablets are correctly packaged.

9. The drug management system according to claim 8, wherein
the tablet has an engraved mark display having a recessed groove part,
the tablet print section includes a conveying unit that conveys a tablet while sucking and supporting the tablet and a printing unit disposed in proximity to the conveying unit and capable of applying print processing to the tablet conveyed by the conveying unit, and
the printing unit applies print processing to the recessed groove part of the engraved mark display along the engraved mark display.
